(19) United States
(12) Patent Application Publication
(10) Pub. No.: US 2018/0024971 A1
(43) Pub. Date: Jan. 25, 2018

(54) EM COLOR SCREEN TEXT abbreviation term EMCST

(71) Applicant: Evelyn Martinez, Bronx, NY (US)

(72) Inventor: Evelyn Martinez, Bronx, NY (US)

(21) Appl. No.: 15/703,915

(22) Filed: Sep. 13, 2017

Related U.S. Application Data
(63) Continuation of application No. 15/530,556, filed on Jan. 28, 2017, now abandoned.
(60) Provisional application No. 62/388,556, filed on Feb. 2, 2016.

(51) Int. Cl. G06F 17/21; G06F 3/0484; G06F 17/22; G06F 17/30; G06F 9/445

(52) U.S. Cl. CPC G06F 17/212; G06F 17/30864; G06F 8/61; G06F 17/2247; G06F 3/04845

(57) ABSTRACT

The Inventor set out to develop through Exclusive Software Programming a way for a Web/Internet User to see Web pages that load in black text/white background such as this page and transform it into a background and text color of their choice such as blue, green, gray, etc. It is new because no other Search engine/Web browser is programmed to only display pages in color that come in a black and white combination. It will not display black and white pages ever however the User can print out such pages in black and white as default color.

On Feb. 2, 2016 a Provisional Patent Application (PPA) was Filed by Inventor for the “EM COLOR SCREEN TEXT. The Application number of 62/388,556 was assigned to the Inventor's Application (PPA). The PPA was signed and dated by the Inventor on Jan. 30, 2016 and mailed via US mailed to the USPTO which was received on Feb. 2, 2016 and then Filed.

### BACKGROUND OF THE INVENTION

We live in a technology World where we all count on technology for many and various reasons and needs. Desktop Computers, Laptop/Tablets and Smartphones all run on Hardware and Software that make it possible for us to enjoy it all. Fortunately for Inventors, there is still many more technology to Invent and Improve upon and that's where the “EM Color Screen Text” comes into play.

In order to Surf the Net (Internet), a Web Browser is needed by the Hardware developed and intended to include surfing the internet such as Desktop Computers, Laptops, Tablets/Smartphones. Web Browsers have been around for a longtime and work in conjuction with many other Software and component-based Software to bring about all the Internet has to offer but they need what is called a Web Browser engine sometimes called Layout Engine or Rendering Engine and is a Program that renders marked up content and formatting information (HTML, XML, CSS, XSL, etc.,).

KDE open-source KHTML, WebKit, Gecko, Blink and Microsoft's EdgeHTML are all engines currently in use with top Web Browsers.

### BRIEF SUMMARY OF INVENTION

The “EM Color Screen Text” will serve to work with a web browser as a Layout Search engine in a unique manner rendering webpages that are grabbed or loaded by the search engine in a White background and with Black text and giving it a Color Background such as purple, blue, yellow, brown, etc., and likewise for the text. The Software will be coded so that the engine can work Only with Web Browsers that want User's to see readable material that is in standard white background with black text in a variety of background colors and text pre-selected by the User. The Web Browser/Search Engine will be suited for Desktop Computers/Laptops and for Mobile Browsers/Search Engines for use in Tablets/Smartphones where capable reading of HTML or other language can be reformatted for small screens.

### BRIEF DESCRIPTION OF DRAWINGS

FIG. 1—Illustrates the first phase in the implementation of the EMCST that begins with the User initiating contact with the hardware the software is in.

FIG. 2—Illustrates the User accessing the EMCST Software which will be found in a Search Engine/Web Browser application combo on his/her hardware (Desktop Computer, Laptop, Tablet, Smartphone).

FIG. 3—Illustrates User's Hardware accessing the Search Engine which is working with the Web Browser which is working with the EMCST Software.

FIG. 4—Illustrates EMCST Software operating within the hardware of the User's choice connecting to the World Wide Web (Internet) through the Search Engine/Web Browser and converting the pages it seeks and grabs that are in black text white background into a one color background and color text.

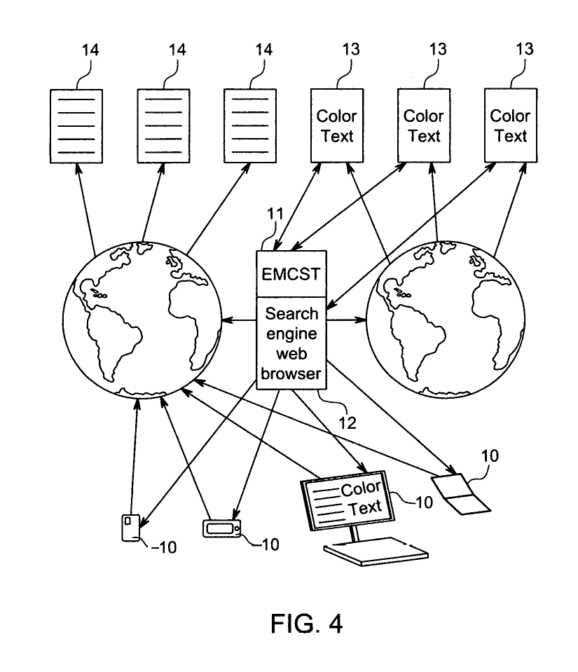

FIG. 5—Illustrates the EMCST Software rendering the Color pages back to the User's hardware (hardware's Screen) in Color.

### DETAILED DESCRIPTION OF THE INVENTION

There are Desktop Computers, Laptops, Tablets and Smartphones being used by billions of people Worldwide for a variety of uses and one of those uses is to Read things Online currently almost everything read online is read with black text on a white background like this page but the “EM Color Screen Text” (EMCST) will change that by giving the User the Exclusive option of selecting the background color and text color they want to view their reading material in when it comes in in the basic colors of black and white. The search engine will take care of that through its coded language propriety software and work with a web browser to bring it to the User.

The Search engine (Web Search Engine) is a software system that searches the Web (Internet) for pages that are requested by a User. The information found is a mix of web pages, images and files of a different type and a Layout engine is a component of a software that combines content and formatting information. It is at that point through Software programming, Source coding and Component-based Software enginieering that the EMCST programming will kick in. The programming will differentiate when a page is going to load in a black text white background color and then proceed to change it to the pre-selected Color scheme preset by the User in a combination of Search Engine/Web Browser support.

The EMCST will allow via a Search Engine/Web Browser Exclusive Programming (described above) to get rid of the longtime white background black text color which is annoyingly boring and eye irratating and replaces it with more soothing and pleasant Color patterns automatically when the page loads. There are many search engines and web browsers out there but not one provides “Exclusive Color Schemes” selection for viewing by the User of loading web pages that come in black text and white background. It's not the same to offer a Color Scheme Selection, such as the EMCST will allow, by licensed's or non licensed's Proprietary Software Intellectual Property rights holder's, as a “choice” for their Users and the options that using this Inventer's invention will provide which is to get rid of the white black combo as the page can only load in Color. This software hasn't been seen exclusively as this Inventor of the EMCST is proposing to make it available to Users of the EM Color Screen Text software.

The Software will be able to operate as a Search Engine/Web Browser enabled combo and made available to function with Desktop Computers/Laptops and Tablets/Smartphones. The Software is adaptable for full size Web funtionality and Mobile Web functionality and although the User can only view pages in Color that presents themselves through the Internet in black text with white background if the User desires to print out the page(s) the search engine/web browser will Default to black text white background for printing purposes.

The Disclosure the Inventor (myself) is presently disclosing, herein, is an exemplification of the Invention and is not to be considered or intented to make the Invention limited to the specified features, use, method illustrated by the figures or description hereby presented below.

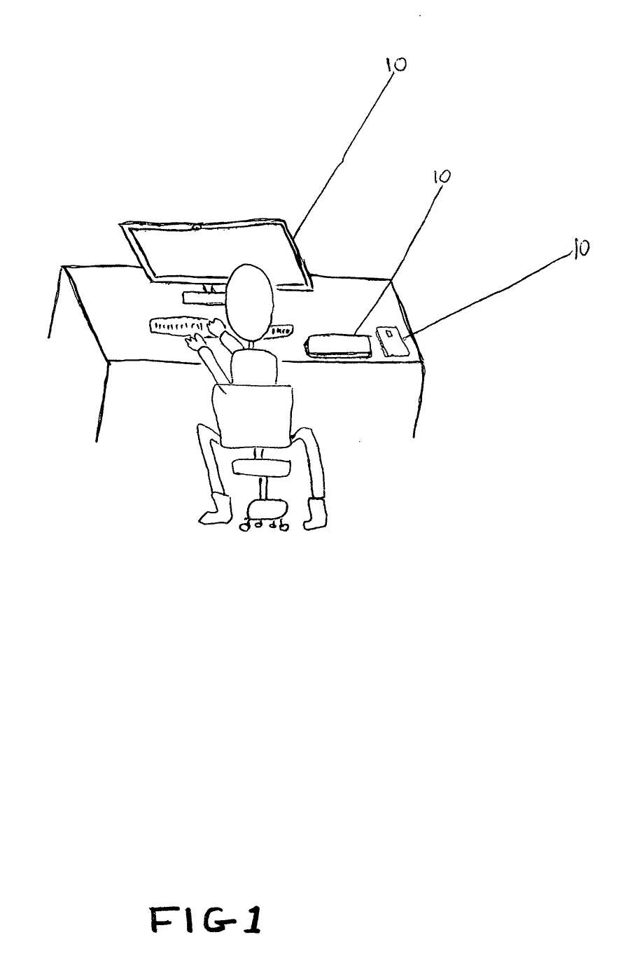

The Invention presented now will be described now by referencing the appended figures. FIG. 1 illustrates how a User would access the EMCST which he/she has loaded into his/her hardware 10 (Desktop Computer, Laptop, Tablet, Smartphone).

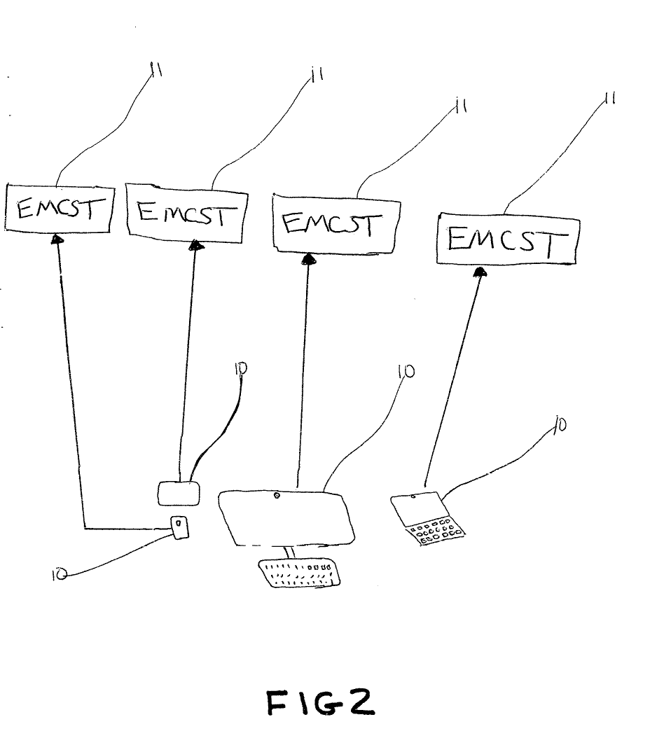

FIG. 2 in abstract, the User accesses his/her hardware 10 (Desktop Computer, Laptop, Tablet or Smartphone) in order to enable the EMCST Software 11 the Software that runs inside a search/web browser.

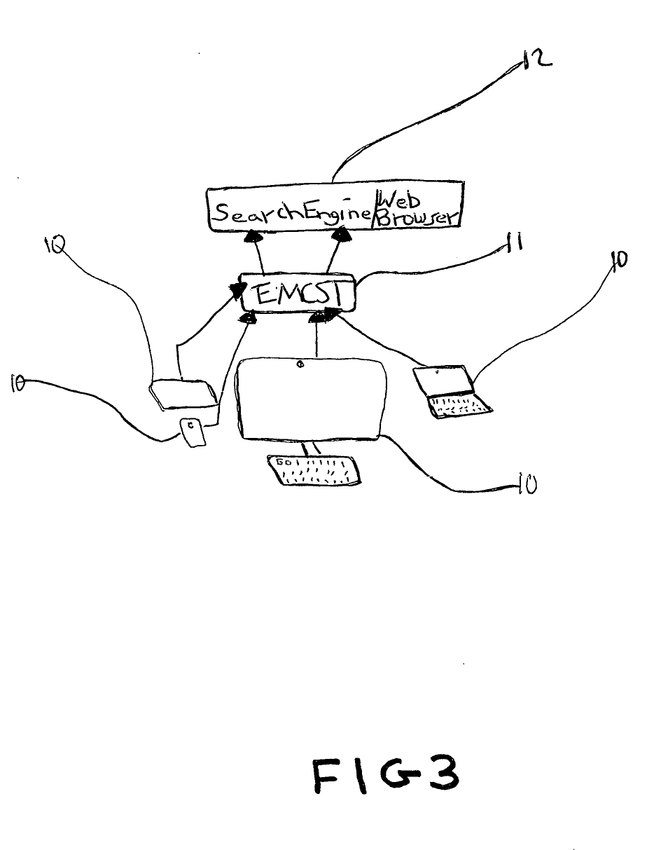

FIG. 3 the User's hardware 10 accesses the EMCST Software 11 that's programmed inside the search engine/web browser 12 which in turn connects to the World Wide Web (the Internet). Once the EMCST Software 11 inside the User's search engine/web browser 12 are interfaced together and connected to the internet the black text/white background pages 14 sought by the User is converted to Color pages 13 via the EMCST Software 11 in combination with the search engine/web browser 12.

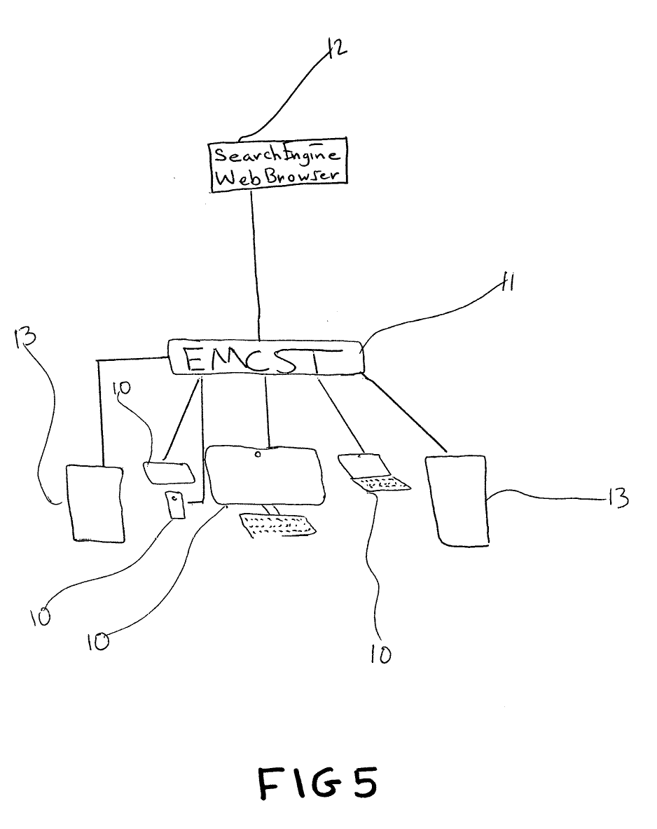

FIG. 5 the EMCST Software 11 worked inside the search engine/web browser 12 and rendered the intended outcome to the User's hardware 10 Color viewable pages and text 13.

The Inventor's Illustration's and description's herein found will seem almost as if other software programs may perform and/or operate in the same function and/or result in like results. The Inventor's (myself) Claims will cover such apparent similarities and clarify opposite.

1) EMCST uses Software programming via source code programming and component-based development (CBD) also known as component-based Software engineering that creates a unique and exclusive experience for the User of the hardware it is operating in such as a desktop computer, laptop, tablet or smartphone. The User of such hardware the software is installed in is provided with the choice via the programmed Search Engine/Web Browser of viewing web pages that are coming in as a black text, white background pages in Color pre-selected by the User beforehand.

2) The Inventor claims that although there are many search engines and web browsers in the market EMCST offers an exclusive function that will be obvious to the User as very different from the others. The difference is that it cannot be viewed in black text white background except when the User desires to print the page then the Software program will default to black text white background as it prints out the page.

3) It is claim that due to the exclusive purpose of the EMCST Software that will run the Search Engine/Web Browser the Inventor claims Intellectual Property Rights on its Proprietary software.
